(19) United States
(12) Patent Application Publication
(10) Pub. No.: US 2016/0046014 A1
(43) Pub. Date: Feb. 18, 2016

(54) MULTI-BIT TOOL

(71) Applicant: W .E. Shine Marketing, Inc., Waxhaw, NC (US)

(72) Inventor: William E. Shine, III, Waxhaw, NC (US)

(21) Appl. No.: 14/824,159

(22) Filed: Aug. 12, 2015

Related U.S. Application Data
(60) Provisional application No. 62/037,666, filed on Aug. 15, 2014.

(51) Int. Cl. B25G 1/08

(52) U.S. Cl. CPC B25G 1/085

(57) ABSTRACT

A multi-bit tool is disclosed. The multi-bit tool includes a handle positioned at a medial portion of the multi-bit tool, a receiver operably connected to the handle at a first end of the multi-bit tool, and a rotating cap. The handle defines a storage chamber for receiving and storing multi-tier cartridge therein. The multi-tier cartridge includes at least one divider configured to divide the cartridge into at least two tiers and at least one retainer clip positioned in each of the at least two tiers. The divider includes at least one slot for receiving and securing a tool therein having a length sufficient to extend across more than one of the at least two tiers.

### BACKGROUND OF THE INVENTION

The present invention relates generally to a multi-bit tool. More particularly, the present invention relates to a screwdriver having a handle with a storage chamber capable of containing screwdriver bits, extensions, drill bits, and the like.

The use of multi-bit tools is well known. In the case of multi-bit screwdrivers, it is well known to contain screwdriver bits within the handle. Unfortunately, in the case of screwdrivers, the storage compartment for the bits is limited to securing screwdriver bits and in some cases only shorter screwdriver bits. This design limits the usefulness of the screwdriver and requires the user to carry other tools or storage compartments.

These limitations of the traditional multibit screwdriver affect a multitude of tool users. Whether it be a DIYer, carpenter, electrician, plumber, janitor, maintenance person, HVAC trades person, etc. in the course of doing a project or their job, they need fastener drive tools that will not only drive screws, but also other common fasteners like nuts, bolts, etc.

In addition to the benefit of having a variety of different types of fastener drive tools, it is important to have these tools in a compact, easily accessible, easily handled storage compartment that stays attached to the handle when pulled out. This makes it easy to hold the handle/retractable cartridge in one hand and use the other hand to place the individual bits/accessories into the shaft or back in storage in the cartridge. Multi bit drivers with cartridges that detach from the handle need three hands, one to hold the handle, one to hold the cartridge, and one to hold the individual bit/accessory. There are a multitude of circumstances where the tool user does not have the ability to place the multi-bit handle down in order to access the bits or sockets. These situations include, but are not limited to working on ladders, in tight or cramped locations, under objects, etc.

Along with the need for easy, convenient access and handling of the bits, it is important to have a larger number of different bits stored in the handle. All of the different multi-bit tool users mentioned above come across a large variety of different types of fasteners and they need a large variety of bits. Popular bit types include Phillips, Torx, Square, Slot, Hex, Security Pin Torx, Security Pin Hex, Security “Snake Eye”, etc. With 4-8 different popular sizes in each type of bit, multi-bit tool users need a multi-bit driver that can handle a large number of bit type and sizes.

There are other occasions where there needs to be a longer length of the multi-bit driver shaft to reach into tight or limited access places. Without an extension stored in the handle, the tool user must retreat to their tool box or other storage area, wasting time.

Accordingly, there is a need for a multi-bit tool capable of storing various types of bits, bits at differing lengths, extensions, and the like; and that addresses the shortfalls of the tools currently on the market.

### BRIEF SUMMARY OF THE INVENTION

These and other shortcomings of the prior art are addressed by providing a multi-bit tool having a storage chamber of sufficient size to store bits of various designs and lengths for use in the multi-bit tool.

The multi-bit tool provides a stacked handle cartridge storage system. With a double stacked cartridge up to 25 different drive tools are available. Triple, quad, etc. stacked cartridges can dramatically increase the types and variety of drive tools that can be stored. The cartridge is designed to hold various lengths of bits, various sizes of nut and bolt drive tools, shaft extensions and other functional tools and accessories.

In summary, the multi-bit tool addresses: considerably greater storage of different types and sizes of bits that are easily and conveniently accessible all while in the hands of the user; allows for the storage of oversize sockets, extensions, bits, etc. all while keeping a handle diameter that is comfortable for most multi-tool users; and provides a handle length and handle surface design that allows for the power of two hands to tighten or loosen tough fasteners. The multi-bit tool also incorporates a handle cap that provides truly functional “ratchetless ratcheting”.

### BRIEF DESCRIPTION OF THE DRAWINGS

The subject matter that is regarded as the invention may be best understood by reference to the following description taken in conjunction with the accompanying drawing figures in which:

FIG. 1 shows a multi-bit tool in a storage or closed position according to an embodiment of the invention;

FIG. 2 is a top view of the multi-bit tool of FIG. 1;

FIG. 3 is a bottom view of the multi-bit tool of FIG. 1;

FIG. 4 is an exploded view of the multi-bit tool of FIG. 1;

FIG. 5 shows the multi-bit tool of FIG. 1 in an overly extended position with tools and/or bits stored in a cartridge of the multi-bit tool;

FIGS. 6 and 7 shows the multi-bit tool of FIG. 1 in the storage position with tools and/or bits stored in the cartridge of the multi-bit tool;

FIGS. 8 and 9 show a divider of the cartridge of FIG. 5;

FIG. 10 shows a tool bit holder of the cartridge of FIG. 5; and

FIGS. 11 and 12 show ends of the cartridge of FIG. 5.

### DETAILED DESCRIPTION OF THE INVENTION

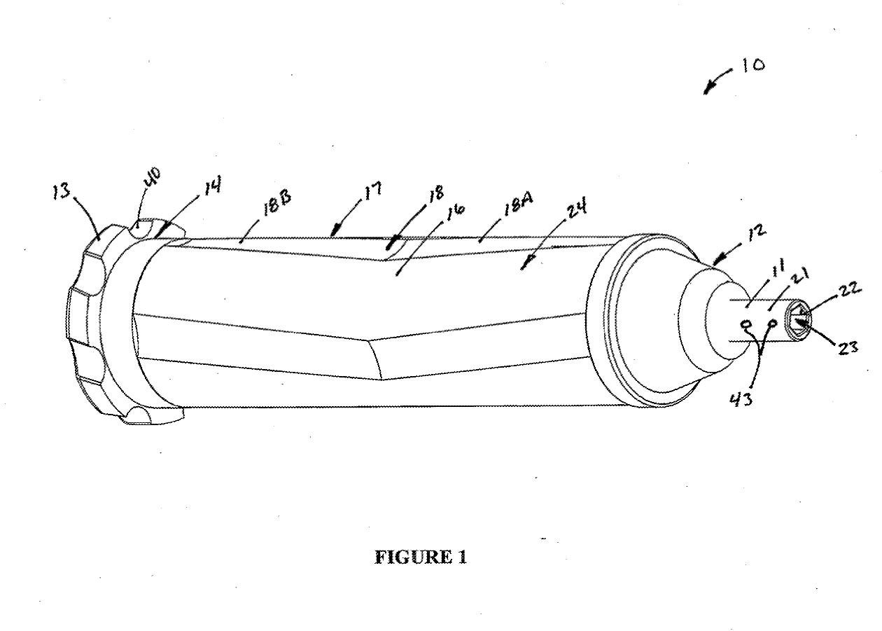

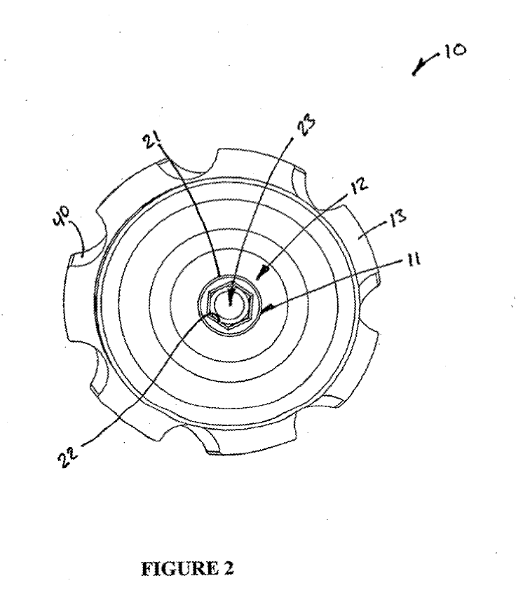

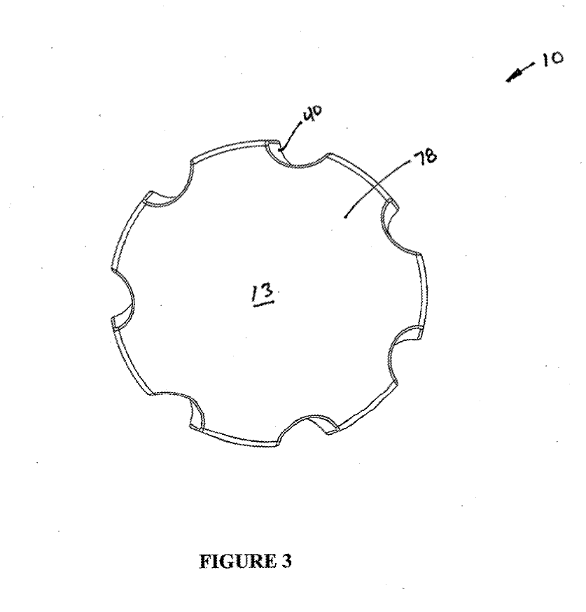

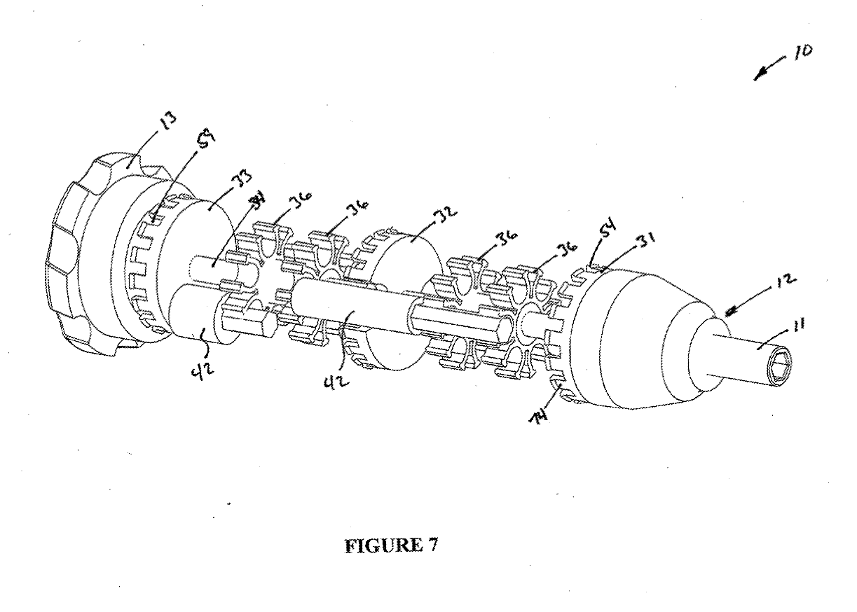

Referring now to the drawings, a multi-bit tool is illustrated in FIGS. 1-7 and shown generally at reference numeral 10. The tool 10 includes a receiver 11 located at a first end 12 of the tool 10 for receiving a bit 42 therein, a rotating cap 13 located at a second end 14 to allow a user to rotate the tool 10 in his/her hand, and a handle 16 located at a medial portion 17 between the first and second ends 12 and 14 of the tool 10 to allow a user to grip the tool 10. As shown, the handle 16 includes grooves 18 formed in an outer surface 24 of the handle 16 to aid a user in gripping and rotating the tool 10. It should be appreciated that other forms of gripping aids such as ridges, dimples, etc. may be incorporated into the handle 16.

The receiver 11 may be integrally formed, operably connected, secured and/or connected at the first end 12 to the handle 16 and includes an outer surface 21 and an inner surface 22 which defines an opening 23 extending into at least a portion of the receiver 11 to allow a bit to be received therein. The receiver 11 may be of a fixed or ratcheting type. The opening 23 has a hexagonal profile to mate with standard hexagonal bits and to allow a user to use the opening for appropriate sized bolts or nuts. It should be appreciated that other suitable profiles may be used for specialty bits, etc. The receiver 11 may also include one or more staggered detents and/or apertures 43 to receive a ball of different length bits 42 therein, thereby securing the bit 42 in the opening 23 of the receiver 11.

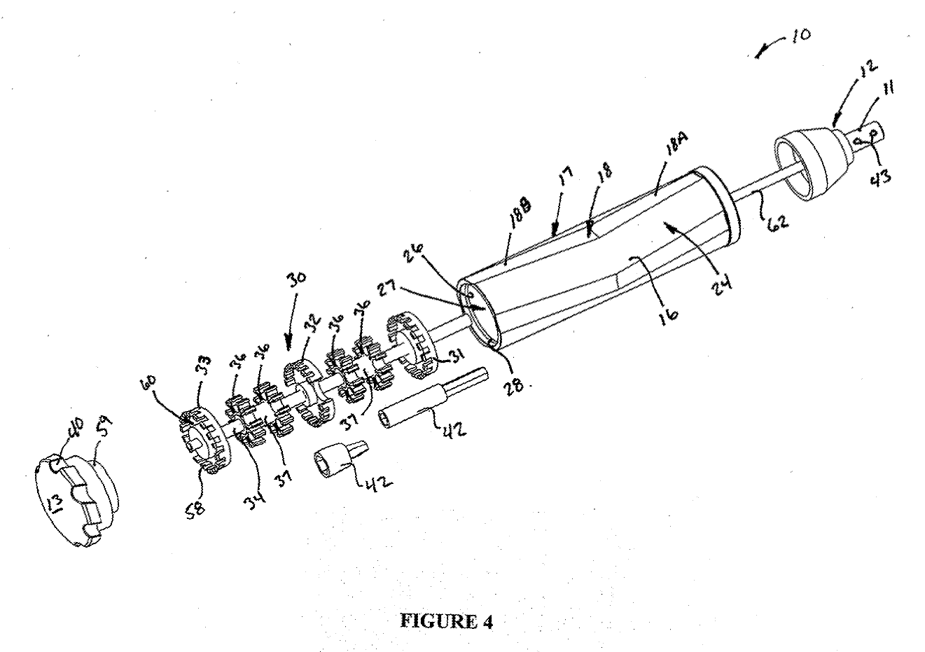

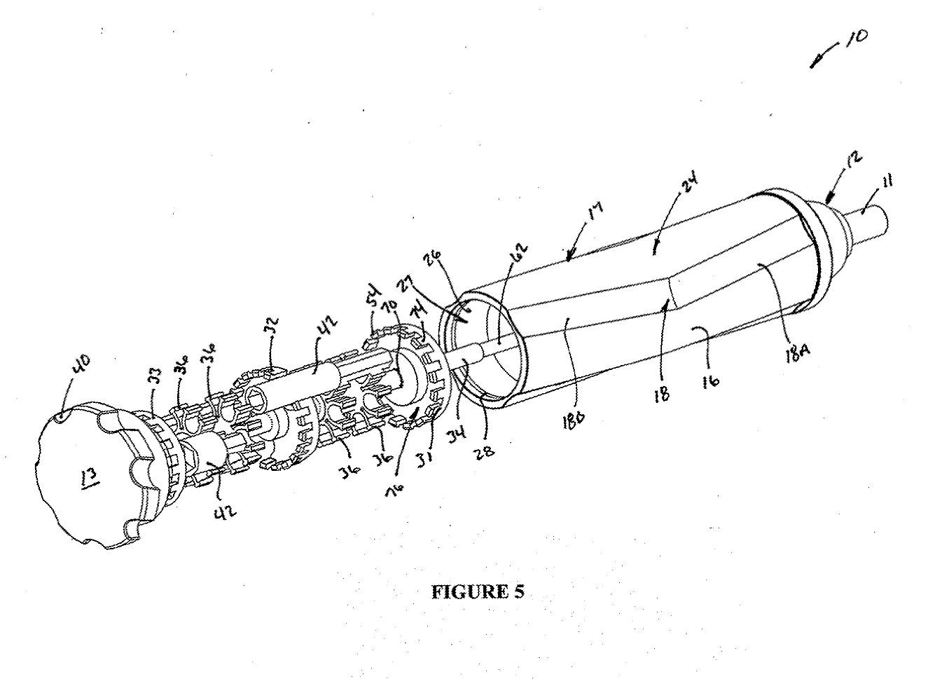

The handle 16 is generally cylindrical and includes an outer wall surface 24 and an inner wall surface 26 that defines a storage chamber 27, FIGS. 4 and 5. The storage chamber 27 is generally cylindrical and has a length sufficient to contain a multi-tier cartridge 30 (described below). It should be appreciated that the storage chamber 27 may be also be generally rectangular, triangular, or any other suitable shape. The inner wall surface 26 further includes at least one detent 28 to prevent the cartridge from dislodging from the chamber 27. As shown, the detent 28 is a groove formed in and around a periphery of the inner wall surface 26. It should be appreciated that the detents 28 may be of any suitable form or shape, such as cylindrical or parallel concentric cylindrical detents, to prevent the cartridge 30 from dislodging from the chamber 27. As shown, the handle 16 includes both cylindrical and parallel concentric cylindrical detents 28.

The length of the handle 16 allows for two hands to provide extra torque versus one hand. The extra torque is often needed to provide extra tightening of nuts, bolts and screws and extra un-tightening of stuck nuts, bolts and screws. As discussed above, the handle 16 includes grooves 18 to aid in gripping and rotating. A top half 18A of the groove 18 reduces hand slippage when turning the tool 10 clockwise while a bottom half 18B of the groove 18 reduces hand slippage when turning the tool 18 counter clockwise.

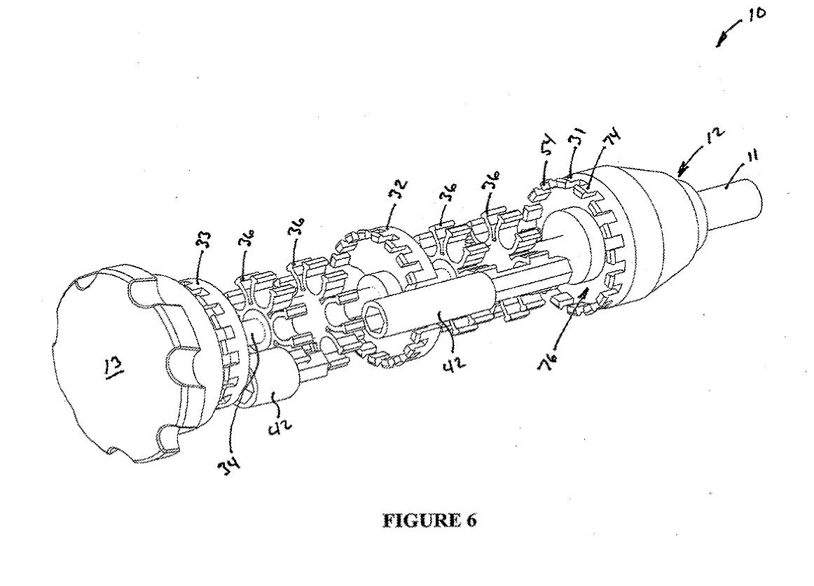

Referring to FIGS. 4-7, the rotating cap 13 is connected to the cartridge 30. The cartridge 30 is designed to slide into the chamber 27 for storage. As shown, the cartridge 30 is a two tier cartridge; however, it should be appreciated that additional tiers may be used. The cartridge 30 includes a first end 31 interconnected to a divider 32 and a second end 33 by a shaft 34. The second end 33 is connected to the rotating cap 13 by the shaft 34 and by sliding fingers 58 of the second end 33 over a hub 59 of the cap 13, thereby receiving the hub 59 in a recess 60 of the cap 13 and allowing the fingers 58 to provide a compression fit over the hub 59. As shown in FIG. 5, the shaft 34 is larger than shaft 62 extending in through the storage chamber 27 to allow the cartridge to slide and rotate thereon. Bit holders or retainer clips 36 are positioned on the shaft 34 between the first end 31 and the divider 32 and between the second end 33 and the divider 32 to create the two tier cartridge. As illustrated, the bit holders 36 include spacers 37 to space the holders 36 from the shaft 34, thereby allowing bits 42 that have larger diameters, such as nut drivers, to be secured to the cartridge 30 and stored in the chamber 27. See FIGS. 5 and 6. It should be appreciated that instead of spacers 37, the shaft 34 may have varying diameters.

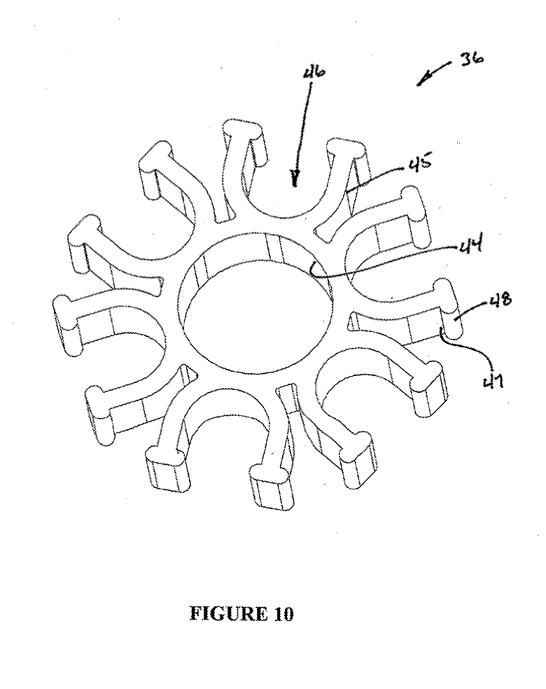

As shown in FIG. 10, the bit holders 36 include an aperture 44 to receive the spacers 37 and/or shaft 34 therethrough and a plurality of fingers 45 cooperating to form channels 46 for receiving and securing a bit 42 therein. As shown, the channel 46 is U-shaped; however, it should be appreciated that other shapes, such as V-shaped may be used. Ends 47 of the fingers 45 also include extensions 48 extending generally perpendicular to each of the fingers 45, generally forming a T-shape, to aid in securing the bit 42 in the channels 46.

In addition to allowing the storage of items such as nut drivers that have a larger diameter than the standard hex, cylindrical, square and round objects, the varying diameters of the shaft 34 or spacers 37 permits the handle 16 to maintain a comfortable handle size for the average user.

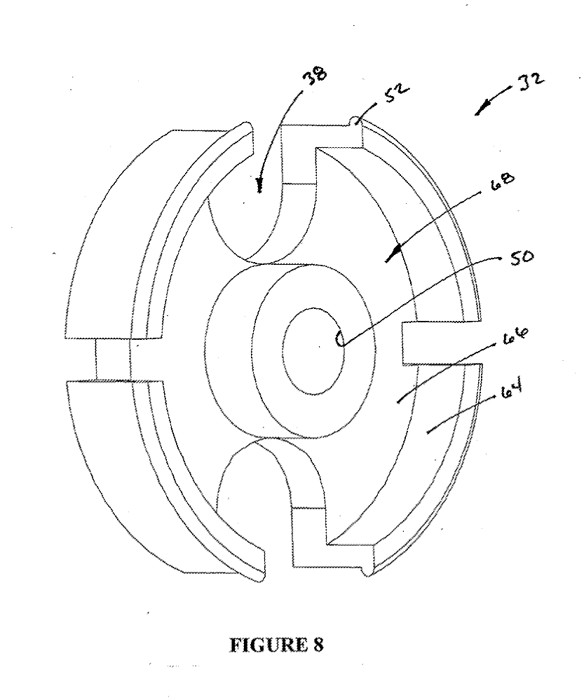

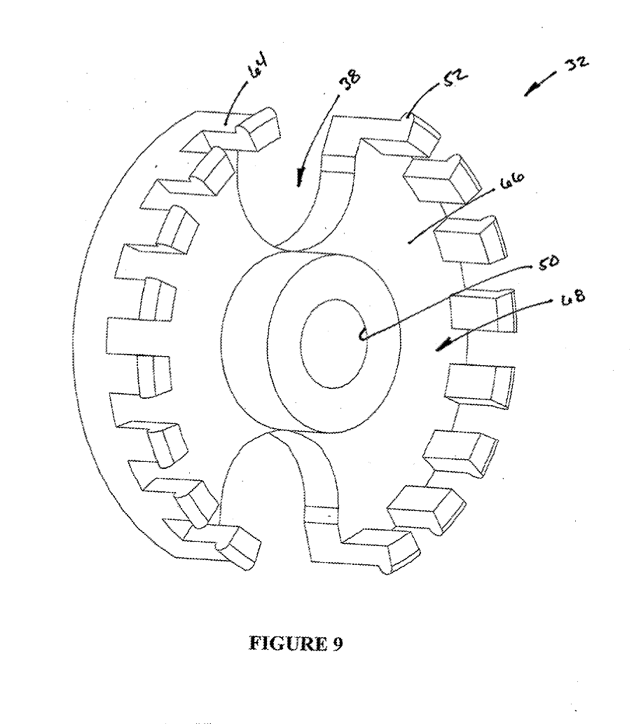

The divider 32, FIGS. 8 and 9, includes an aperture 50 for receiving the shaft 34 therethrough and at least one slot 38 therein to provide additional types of storage capacity. As shown, the slot 38 allows an extension or other long instrument, such as a drill bit, to be secured to the cartridge 30, FIGS. 5 and 6. It should be appreciated that the divider 32 may have multiple slots spaced around a periphery of the divider 32. In addition, the divider 32 includes at least one lip 52 around a periphery of the divider 32 for engagement with the at least one detent 28 to provide resistance to pulling the cartridge 30 out of the handle 16 past the divider 32. As shown, the lip 52 is associated with fingers 64 extending outwardly from body 66 to create recess 68; however, it should be appreciated that the lip 52 could be positioned around a periphery of the body 66. The divider 32 may have no fingers, may have minimal fingers 64 (FIG. 8), or may have a lot of fingers 64 (FIG. 9).

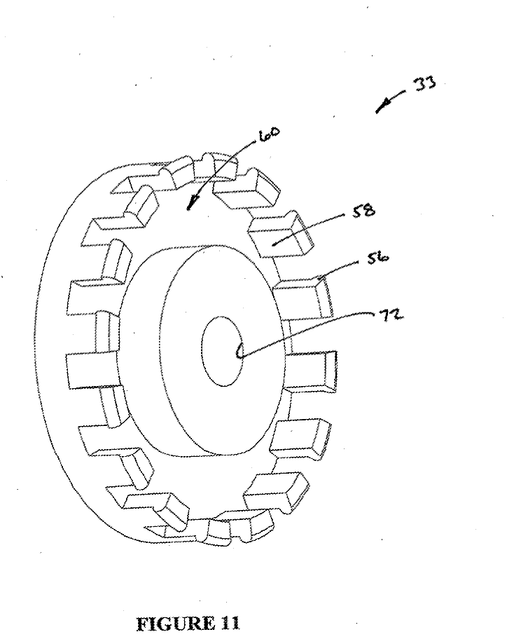

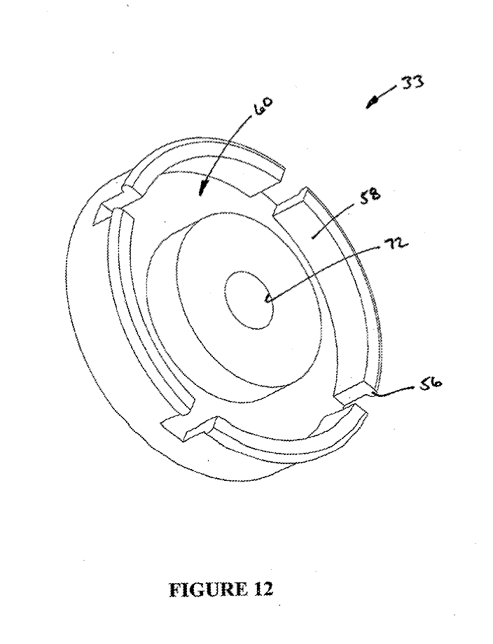

The first and second ends 31 and 33, FIGS. 11 and 12 (only second end 33 is shown for clarity), each include at least one lip 54 and 56 extending around a periphery of each of the first and second ends 31 and 32 and an aperture 70, 72 respectively. As discussed above with reference to the divider 32, the lips 54 and 56 engage the at least one detent 28 to provide resistance to pulling the cartridge 30 out of the handle 16. More particularly, the lip 56 on second end 33 provides a first resistance to pulling the cartridge 30 out of the handle 16, thereby maintaining the multi-tool in a storage and/or closed position. The lip 52 on the divider 32 provides a second resistance to pulling the cartridge 30 past the divider 32, thereby exposing only a first tier of the cartridge 30. The lip 54 on the first end 31 provides a third resistance to pulling the cartridge 30 past an extended position to an overly extended position, as shown in FIG. 5. It should be appreciated that the first end 31 may also include fingers 74 and recess 76 like that described with respect to second end 33.

As noted above, the rotating cap 13 is connected to the cartridge 30; thus, when the cap 13 is rotated, the cartridge 30 also rotates within the chamber 27. It should be appreciated that the cap 13 may be designed to rotate without rotating the cartridge 30 or rotate with the cartridge without rotating the handle. As shown in FIGS. 1-7, the cap 13 has a generally or substantially flat bottom surface 78 to allow the tool 10 to be placed standing vertically on the cap 13. This makes it easy to grab or retrieve the tool 10 when it is momentarily put down, especially for someone wearing protective gloves, winter gloves, someone with greasy hands, etc. The cap 13 has a slightly larger diameter than the diameter of the handle 16 and includes grooves 40 around a periphery of the cap 13 to provide resistance from the tool 13 rolling away when lying in a horizontally or prone position and to aid a user in gripping the cap 13 during use which allows a user to use the tool 10 with a “ratchetless ratchet” motion.

The “ratchetless ratchet” motion allows a user to maintain contact with the tool 10 while turning the tool 10 to drive a screw, nut, etc. When using a standard fixed end screwdriver, the user must turn the handle to drive the screw. The user's hand then has to break contact with the driver to reposition their hand to make the next turning of the screwdriver. A ratcheting screwdriver allows the user to constantly maintain contact with the handle making the turning of the screwdriver faster and easier. The down side of making ratcheting screwdrivers is that the ratcheting mechanism can break when significant torque is applied to turning the screwdriver. The oversized cap, which rotates freely and the grooves in the cap allows for the same “ratcheting” movement without the cost and possible breakage of the ratcheting mechanism.

In use, the cartridge 30 is loaded up with tool bits, see FIGS. 4-7, and pushed into the chamber 27 for storage. When a tool bit is needed, the user pulls on the cap 13 which moves the cartridge 30 from the storage position, FIGS. 1, 6, and 7, to an open position, FIG. 5 (with the exception that the first end 31 would not be pulled past the detent 28). The parallel concentric cylindrical detents or grooves 28 interlock with the divider 32 of the cartridge 30 and the cap 13 to keep the handle 16 from wobbling when the cartridge 30 is withdrawn from the handle 16. A cylindrical detent 28 interacts with the first end 31 and prevents the cartridge 30 from being pulled out of the handle 16.

It should be appreciated that the pulling out and pushing in of the cartridge 30 can, but does not require the need of shaft 62 for the cartridge 30 to slide and rotate thereon. As mentioned above, the interior of the handle 16 has parallel concentric cylindrical detents that interact with the divider 32, first and second ends 31, 33, and the cap 13 to prevent the handle 16 from wobbling when the cartridge 30 is pulled out or pushed into the handle 16. The elimination of the center shaft 62 in the handle 16 reduces manufacturing cost and product weight making it easier for the tool to be used. For a variety of reasons, the driver could be made with a center shaft, different and less costly than center shafts in existing products. This unique process would also make little difference in the overall weight of the tool.

Once the cartridge 30 is pulled out of the handle 16, the user chooses a bit 42 and inserts it into the receiver 11 for use. The user then pushes the cartridge 30 back into the chamber 27 for storage. As the user rotates the tool 10 to screw in a screw, nut, etc. the cap 13 rotates in the user's hand allowing the user to maintain constant contact with the tool. When the user is finished using the bit, the cartridge 30 is pulled out of the handle 16 and the bit 42 removed from the receiver 11. The bit 42 is secured in the cartridge 30 and the cartridge 30 is pushed back into the chamber 27 for storage.

The foregoing has described a multi-bit tool. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

I claim:

1. A multi-bit tool, comprising:
(a) a handle positioned at a medial portion of the multi-bit tool, the handle having an inner wall surface defining a storage chamber for receiving a multi-tier cartridge therein, the multi-tier cartridge having:
(i) at least one divider configured to divide the multi-tier cartridge into at least two tiers, the divider having at least one slot for receiving and securing a tool therein having a length sufficient to extend across more than one of the at least two tiers; and
(ii) at least one retainer clip positioned in each of the at least two tiers, the retainer clips configured to receive and secure a tool in one of the at least two tiers;
(b) a receiver operably connected to the handle at a first end of the multi-bit tool and configured to receive a tool therein;
(c) a rotating cap operably connected to the multi-tier cartridge at a second end of the multi-bit tool, the rotating cap being configured to rotate with respect to the handle during use; and
(d) wherein the rotating cap allows a user to move the multi-tier cartridge from a storage position where the cartridge is enclosed by the storage chamber and an open position where the cartridge is exposed to allow a user to remove tools therefrom for use or secure tools therein for storage.

2. The multi-bit tool according to claim 1, further including at least one groove formed in an outer surface of the handle, the at least one groove having a first portion configured to provide a gripping mechanism when turning the multi-bit tool clockwise and a second portion configured to provide a gripping mechanism when turning the multi-bit tool counter-clockwise.

3. The multi-bit tool according to claim 1, wherein the inner wall surface further includes at least one detent to resist pulling the multi-tier cartridge out of the storage chamber.

4. The multi-bit tool according to claim 3, wherein the multi-tier cartridge further includes first and second spaced-apart ends, the first end including at least one lip extending around a periphery of the first end to engage the at least one detent and resist pulling the multi-tier cartridge out of the storage chamber past the open position, the second end including:
(a) fingers disposed around a periphery of the second end, the fingers forming a recess for receiving a portion of a hub of the rotating cap therein; and
(b) at least one lip extending around a periphery of the second end to engage the at least one detent and resist pulling the multi-tier cartridge out of the storage chamber from the storage position to the open position.

5. The multi-bit tool according to claim 1, wherein the rotating cap has a diameter greater than a diameter of the handle and includes grooves disposed around a periphery of the rotating cap to provide resistance against rolling when the multi-bit tool is laid horizontally on a surface.

6. The multi-bit tool according to claim 1, wherein the rotating cap includes a substantially flat bottom surface configured to allow a user to stand the multi-bit tool vertically on a surface.

7. A multi-bit tool, comprising:
(a) a handle positioned at a medial portion of the multi-bit tool, the handle having an outer wall surface configured for a user to grip and an inner wall surface defining a storage chamber for receiving a multi-tier cartridge therein, the multi-tier cartridge having:
(i) a first shaft extending a length of the cartridge;
(ii) at least one divider disposed along the first shaft and configured to divide the cartridge into at least two tiers, the divider having at least one slot for receiving and securing a tool therein having a length sufficient to extend across more than one of the at least two tiers; and
(iii) at least one retainer clip positioned in each of the at least two tiers, the at least one retainer clip being spaced from the first shaft and configured to receive and secure a tool in one of the at least two tiers;
(b) a receiver operably connected to the handle at a first end of the multi-bit tool and configured to receive a tool therein;
(c) a rotating cap operably connected to the multi-tier cartridge at a second end of the multi-bit tool, the multi-bit tool having a substantially flat bottom surface to permit the multi-bit tool to be placed vertically on a surface and is configured to rotate with respect to the handle during use; and
(d) wherein the rotating cap allows a user to move the multi-tier cartridge from a storage position where the cartridge is enclosed by the storage chamber and an open position where the cartridge is exposed to allow a user to remove tools therefrom for use or secure tools therein for storage.

8. The multi-bit tool according to claim 7, wherein the at least one retainer clip is spaced from the first shaft by a spacer to permit storage of a nut driver.

9. The multi-bit tool according to claim 7, further including at least one groove disposed in the outer surface of the handle.

10. The multi-bit tool according to claim 9, wherein the at least one groove includes a first groove portion configured to provide a gripping mechanism when turning the multi-bit tool clockwise and a second groove portion configured to provide a gripping mechanism when turning the multi-bit tool counter-clockwise.

11. The multi-bit tool according to claim 7, wherein the multi-tier cartridge further includes first and second spaced-apart ends disposed on the first shaft.

12. The multi-bit tool according to claim 11, wherein each of the first and second spaced-apart ends include:
(a) fingers disposed around a periphery of the ends, the fingers defining a recess; and
(b) a lip disposed around a periphery of the fingers, the lip configured to mate with at least one detent disposed on the inner wall surface of the handle to provide a resistance to pulling the cartridge out of the storage chamber from the storage position to the open position.

13. The multi-bit tool according to claim 12, wherein a hub of the rotating cap is received in the recess of the second end such that the fingers form a compression fit around a periphery of the hub.

14. The multi-bit tool according to claim 7, further including a second shaft extending from the first end through the storage chamber, the second shaft having a diameter smaller than the first shaft to permit the first shaft to linearly slide over the second shaft, thereby maintaining alignment of the cartridge when moving from the storage position to the open position and from the open position to the storage position.

15. The multi-bit tool according to claim 7, further including staggered detents positioned in an inner surface of the receiver to secure tools of varying lengths therein.

16. The multi-bit tool according to claim 7, wherein the receiver is integrally formed with the handle.
